(19) United States
(12) Patent Application Publication
(10) Pub. No.: US 2017/0182713 A1
(43) Pub. Date: Jun. 29, 2017

(54) POWDER FEEDING APPARATUS FOR THREE-DIMENSIONAL PRINTER

(71) Applicant: SENTROL Co., Ltd., Seoul (KR)

(72) Inventors: Takada Toru, Seoul (KR); Seung Hwan Joo, Seoul (KR)

(21) Appl. No.: 15/182,882

(22) Filed: Jun. 15, 2016

(30) Foreign Application Priority Data
Dec. 24, 2015 (KR) 10-2015-0186369

(51) Int. Cl. B29C 67/00; B33Y 30/00

(52) U.S. Cl. CPC B29C 67/0085; B33Y 30/00; B29K 2105/251

(57) ABSTRACT

A powder feeding apparatus for a three-dimensional printer, and more particularly, to a powder feeding apparatus for a three-dimensional printer that can quickly and simply perform horizontal adjustment of a blade that pushes and flattens powder and gap adjustment between a worktable and a blade is provided. The powder feeding apparatus for a three-dimensional printer includes: a main body installed to move in a horizontal direction at an upper portion of a worktable and having a discharge portion that discharges powder at a lower end portion; first and second moving plates installed at both sides of the discharge portion of the main body to form a passage that guides powder discharged from the discharge portion to the worktable; first and second blades fixedly installed at the first and second moving plates, respectively, to push and flatten powder supplied to the worktable, when the main body moves in a horizontal direction; first and second mechanism bodies fixedly installed at one end portion and the other end portion, respectively, of the main body; and first and second adjustment units installed to vertically move in the first and second mechanism bodies while being coupled to lateral both end portions of the first and second moving plates, respectively.

### BACKGROUND OF THE INVENTION

Field of the Invention

The present invention relates to a powder feeding apparatus for a three-dimensional printer, and more particularly, to a powder feeding apparatus for a three-dimensional printer that can quickly and simply perform horizontal adjustment of a blade that pushes and flattens powder and gap adjustment between a worktable and a blade.

Description of the Related Art

Nowadays, a research on a three-dimensional printer that can shape a target object using three-dimensional (3D) data has been actively performed. Because a complex structure of product can be easily shaped and produced with a planned design, it is expected that a 3D printer market will largely grow in the future.

stacked type 3D printer using powder repeats a work that spreads powder in a small thickness of about 30-150 um and that bonds the powder with a bonding resin or that sinters or melts the powder using laser to combine the powder and that spreads again the powder in a small thickness of about 30-150 um.

In this case, a device that evenly spreads powder in a small thickness is referred to as a ‘squeezer’ or ‘blade’, and technology that evenly spreads powder using the blade is core technology of a 3D printer using powder. Therefore, in a stacked type 3D printer, in order to maintain a horizontal state of a blade using a plurality of actuators and motors and to stack powder in a desired thickness, a work that accurately maintains a gap between the blade and a worktable is performed.

However, because such a conventional 3D printer requires an expensive actuator and motor and a program for controlling the actuator and motor, a high production cost is required and a control program is complex and thus there is a problem that work efficiency is deteriorated.

### SUMMARY OF THE INVENTION

The present invention has been made in view of the above problems and provides a powder feeding apparatus for a 3D printer that can quickly and simply perform horizontal adjustment of a blade that pushes and flattens powder and gap adjustment between a worktable and a blade.

In accordance with an aspect of the present invention, a powder feeding apparatus for a 3D printer includes: a main body installed to move in a horizontal direction at an upper portion of a worktable and having a discharge portion that discharges powder at a lower end portion; first and second moving plates installed at both sides of the discharge portion of the main body to form a passage that guides powder discharged from the discharge portion to the worktable; first and second blades fixedly installed at the first and second moving plates, respectively, to push and flatten powder supplied to the worktable, when the main body moves in a horizontal direction; first and second mechanism bodies fixedly installed at one end portion and the other end portion, respectively, of the main body; and first and second adjustment units installed to vertically move in the first and second mechanism bodies while being coupled to lateral both end portions of the first and second moving plates, respectively.

The first and second adjustment units may include: first and second adjustment nuts rotatably installed in the first and second mechanism bodies, respectively; first and second adjustment bolts screw-coupled to the first and second adjustment nuts to vertically move by a rotation of the first and second adjustment nuts, respectively; and first and second adjustment blocks installed at a lower end portion of the first and second adjustment bolts, respectively, to couple to one end portion and the other end portion of the first and second moving plates, respectively.

At one side of the first and second mechanism bodies, cut-out grooves may be each formed, and the first and second adjustment nuts may be installed at the first and second cut-out grooves, respectively, to expose a portion thereof to the outside.

The first and second adjustment blocks may be detachably coupled to the first and second moving plates, respectively.

The first and second fastening plates that fix the first and second blades to the first and second moving plates, respectively, may be screw-coupled to a side surface of the first and second moving plates.

### Advantages

A powder feeding apparatus for a 3D printer according, to the present invention can perform horizontal adjustment of a blade and gap adjustment between the blade and a worktable by moving the blade in a vertical direction using an adjustment unit.

Therefore, because an expensive motor and actuator are not required, a production cost can be reduced and because a complex control program is not required, work efficiency can be improved.

### BRIEF DESCRIPTION OF THE DRAWINGS

The objects, features and advantages of the present invention will be more apparent from the following detailed description in conjunction with the accompanying drawings, in which:

FIG. 1 is a diagram illustrating an entire structure of a powder feeding apparatus for a 3D printer according to an exemplary embodiment of the present invention;

FIG. 2 is a side view illustrating a powder feeding apparatus for a printer according to an exemplary embodiment of the present invention;

FIG. 3 is a diagram illustrating an internal structure of a powder feeding apparatus for a 3D printer according to an exemplary embodiment of the present invention; and

FIG. 4 is a diagram illustrating an operation state of a powder feeding apparatus for a 3D printer according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. Like reference numerals designate like elements throughout the specification. Detailed descriptions of well-known functions and structures incorporated herein may be omitted to avoid obscuring the subject matter of the present invention.

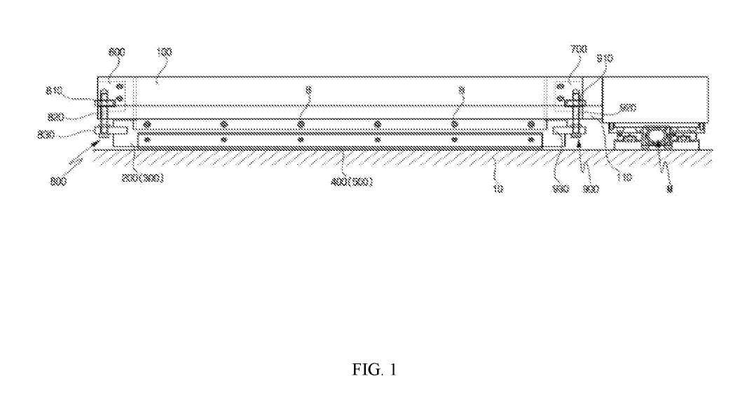

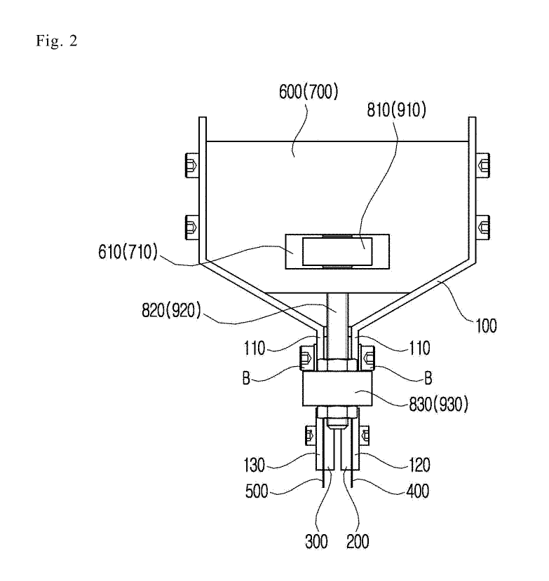

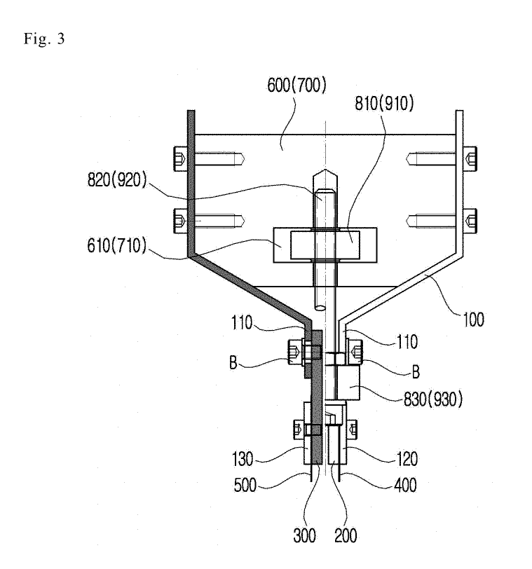

FIG. 1 is a diagram illustrating an entire structure of a powder feeding apparatus for a 3D printer according to an exemplary embodiment of the present invention, FIG. 2 is a side view illustrating a powder feeding apparatus for a 3D printer according to an exemplary embodiment of the present invention, and FIG. 3 is a diagram illustrating an internal structure of a powder feeding apparatus for a 3D printer according to an exemplary embodiment of the present invention.

As shown in FIGS. 1 to 3, a powder feeding apparatus for a 3D printer according to an exemplary embodiment of the present invention includes a main body 100, first and second moving plates 200 and 300, first and second blades 400 and 500, first and second mechanism bodies 600 and 700, and first and second adjustment units 800 and 900.

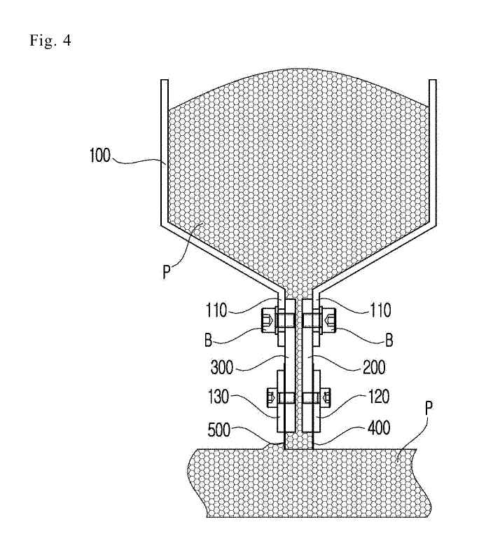

The main body 100 is installed to move in a horizontal direction at an upper portion of a worktable 10 to supply powder P (see FIG. 4) such as metal, synthetic resin, and sand for producing a 3D object to the worktable 10.

For this reason, at one side of the worktable 10, a linear motor M coupled to the main body 100 is installed. As shown in FIGS. 1 to 3, the main body 100 is coupled in a cantilever form to the linear motor M to move in a horizontal direction at an upper portion of the worktable 10 when the linear motor M moves in a horizontal direction.

FIG. 4 is a diagram illustrating an operation state of a powder feeding apparatus for a 3D printer according to an exemplary embodiment of the present invention.

Further, as shown in FIG. 4, at the inside of the main body 100, powder P is filled, and at a lower end portion thereof, a discharge portion 110 that discharges powder P is formed. When the main body 100 moves, the discharge portion 110 is opened to enable powder P to pass through between the first and second moving plates 200 and 300 to be described later and to be supplied to the worktable 10.

Here, the powder P supplied to the worktable 10 is flattened in a predetermined thickness by a blade and is sintered or melted by a bonding resin or laser to be combined, and such powder supply and powder flattening and a powder combination process by sintering or melting is repeatedly performed while a 3D object production process is performed. Therefore, while a 3D object production process is performed, the main body 100 reciprocates in a horizontal direction at an upper portion of the worktable 10 by the linear motor M.

The first and second moving plates 200 and 300 are installed at a. predetermined gap at both sides of the discharge portion 110 of the main body 100 to form a passage that guides powder P to the worktable 10.

Therefore, as shown in FIG. 4, powder P discharged from the discharge portion 110 passes through between the first and second moving plates 200 and 300 to be supplied to the worktable 10 and thus when the powder P is supplied, dust is suppressed from occurring.

The first and second blades 400 and 500 are fixedly installed to the first and second moving plates 200 and 300, respectively, and thus when the main body 100 moves in a horizontal direction, the first and second blades 400 and 500 push and flatten powder P supplied to the worktable 10 via a passage formed by the discharge portion 110 and the first and second moving plates 200 and 300, as described above.

Here, the first arid second blades 400 and 500 are fixed by first and second fastening plates 120 and 130 screw-coupled to a side surface of the first and second moving plates 200 and 300, respectively, and in this case, lower end portions of the first and second blades 400 and 500 are exposed to the outside of the first and second moving plates 200 and 300, respectively. Therefore, when the main body 100 moves in a horizontal direction, a powder flattening work is performed by a lower end portion of the first and second blades 400 and 500.

The first and second mechanism bodies 600 and 700 are fixedly installed to one end portion and the other end portion, respectively, of the main body 100, and while the first and second adjustment units 800 and 900 are coupled to lateral both end portions of the first and second moving plates 200 and 300, the first and second adjustment units 800 and 900 are installed to vertically move to the first and second mechanism bodies 600 and 700.

Therefore, when vertically moving the first and second adjustment units 800 and 900, a vertical movement of the first and second moving plates 200 and 300 and the first and second blades 400 and 500 fixed to the first and second moving plates 200 and 300 is naturally performed and thus a gap formed by the first and second blades 400 and 500 and the worktable 10 can he adjusted.

That is, when vertically moving downward the first and second adjustment units 800 and 900, the first and second moving plates 200 and 300 decline toward the worktable 10 and thus a gap formed by the first and second blades 400 and 500 and the worktable 10 is reduced, and in contrast, when vertically moving upward the first and second adjustment units 800 and 900, the first and second moving plates 200 and 300 move upward and thus a gap formed by the first and second blades 400 and 500 and the worktable 10 increases.

Further, when the first and second blades 400 and 500 do not maintain a horizontal state, a horizontal state of the first and second blades 400 and 500 may be adjusted using the first and second adjustment units 800 and 900. Specifically, when one end portion of the first and second blades 400 and 500 is located lower than the other end portion thereof, by selectively vertically moving the first adjustment unit 800 or the second adjustment unit 900, a horizontal state of the first and second blades 400 and 500 may be maintained.

In this way, when horizontal adjustment of the first and second blades 400 and 500 and gap adjustment between the first and second blades 400 and 500 and the worktable 10 using the first and second adjustment units 800 and 900 are complete, the first and second moving; plates 200 and 300 are fixed to the main body 100 by a fastening bolt B.

Such first and second adjustment units 800 and 900 include first and second adjustment nuts 810 and 910, first and second adjustment bolts 820 and 920, and first and second adjustment blocks 830 and 930, respectively.

The first and second adjustment nuts 810 and 910 are rotatably installed in the first and second mechanism bodies 600 and 700, respectively, and the first and second adjustment bolts 820 and 920 are screw-coupled to the first and second adjustment nuts 810 and 910, respectively, to vertically move by a rotation of the first and second adjustment nuts 810 and 910.

Further, the first and second adjustment blocks 830 and 930 are installed at lower end portions of the first and second adjustment bolts 820 and 920, respectively, to be coupled to one end portion and the other end portion of the first and second moving plates 200 and 300, respectively.

Therefore, when rotating the first adjustment nut 810, the first adjustment bolt 820 vertically moves and thus the first adjustment block 830 and one end portions of the first and second moving plates 200 and 300 move upward or downward, and when rotating the second adjustment nut 910, the second adjustment bolt 920 vertically moves and thus the other end portion of the first and second moving plates 200 and 300 move upward or downward and thus a gap between each blade and the worktable 10 may be adjusted or a horizontal state of the first and second blades 400 and 500 may be adjusted, as described above.

Here, in order to easily rotate the first and second adjustment nuts 810 and 910 at the outside of the first and second mechanism bodies 600 and 700, it is preferable that cut-out grooves 610 and 710 are formed at one side of the first and second mechanism bodies 600 and 700, respectively, and that the first and second adjustment nuts 810 and 910 are installed in the cut-out grooves 610 and 710, respectively, such that a portion of the first and second adjustment nuts 810 and 910 is exposed to the outside.

Further, it is preferable that the first and second adjustment blocks 830 and 930 are detachably coupled to the first and second moving plates 200 and 300. In this case, by separating the first and second moving plates 200 and 300 from the first and second adjustment blocks 830 and 930, as needed, a work of replacing or repairing the first and second moving plates 200 and 300 or the first and second blades 400 and 500 can be simply performed.

While this invention has been described in connection with what is presently considered to he practical exemplary embodiments, it is to be understood that the invention is not limited to the disclosed embodiments, but, on the contrary, is intended to cover various modifications and equivalent arrangements included within the spirit and scope of the appended claims.

[Description of symbols]

| | |
|---|---|
| 100: main body | 110: discharge portion |
| 120: first fastening plate | 130: second fastening plate |
| 200: first moving plate | 300: second moving plate |
| 400: first blade | 500: second blade |
| 600: first mechanism body | 700: second mechanism body |
| 610, 710: cut-out portion | 800: first adjustment unit |
| 900: second adjustment unit | 810: first adjustment nut |
| 910: second adjustment nut | 820: first adjustment bolt |
| 920: second adjustment bolt | 830: first adjustment block |
| 930: second adjustment block | B: fastening bolt |
| P: powder | |

What is claimed is:

1. A powder feeding apparatus for a three-dimensional printer, comprising:
a main body installed to move in a horizontal direction at an upper portion of a worktable and having a discharge portion that discharges powder at a lower end portion;
first and second moving plates installed at both sides of the discharge portion of the main body to form a passage that guides powder discharged from the discharge portion to the worktable;
first and second blades fixedly installed at the first and second moving plates, respectively, to push and flatten powder supplied to the worktable, when the main body moves in a horizontal direction;
first and second mechanism bodies fixedly installed at one end portion and the other end portion, respectively, of the main body; and
first and second adjustment units installed to vertically move in the first and second mechanism bodies while being coupled to lateral both end portions of the first and second moving plates, respectively.

2. The powder feeding apparatus of claim 1, wherein the first and second adjustment units comprise:
first and second adjustment nuts rotatably installed in the first and second mechanism bodies, respectively;
first and second adjustment bolts screw-coupled to the first and second adjustment nuts to vertically move by a rotation of the first and second adjustment nuts, respectively; and
first and second adjustment blocks installed at a lower end portion of the first and second adjustment bolts, respectively, to couple to one end portion and the other end portion of the first and second moving plates, respectively.

3. The powder feeding apparatus of claim wherein at the side of the first and second mechanism bodies, cut-out grooves are each formed, and
the first and second adjustment nuts are installed at the first and second cut-out grooves, respectively, to expose a portion thereof to the outside.

4. The powder feeding apparatus of claim 2, wherein the first and second adjust rent blocks are detachably coupled to the first and second moving plates, respectively.

5. The powder feeding apparatus claim 1, wherein first and second fastening plates that fix the first and second blades to the first and second moving plates, respectively, are screw-coupled to a side surface of the first and second moving plates.
